(19) United States
(12) Patent Application Publication
(10) Pub. No.: US 2004/0160417 A1
(43) Pub. Date: Aug. 19, 2004

(54) Text communication device for divers

(76) Inventor: Yaron Nahum Mandel, Thornhill (CA)

Correspondence Address: Yaron Nahum Mandel, 14 Nottinghill Road, Thornhill, ON, L3T 4X9, CA

(21) Appl. No.: 10/367,027

(22) Filed: Feb. 19, 2003

(51) Int. Cl. G09G 5/00

(52) U.S. Cl. 345/168

(57) ABSTRACT

Underwater communication device for diver communication by text messages. One embodiment is used to communicate text messages visually among divers in the same dive site. It has a keyboard and a display. The diver enters a message on the keyboard. The message appears on the display. The diver shows the display to the other divers in the vicinity, and they read the message. The diver can also select and display standard messages that are factory preset, or custom messages stored by the diver before the dive. A second embodiment is used to communicate text messages by data communication over a wire between divers and a ship, a submarine, an ocean rig or other divers at a distance. Two units of the text communication device are used, each unit connected to one end of the wire, and they function as data communication terminals. It is also possible to connect multiple units to the wire, forming a network. This embodiment also includes a data communication interface such as an ethernet interface, a serial interface or a telephone modem.

### BACKGROUND

1. Field of the Invention

This invention relates in general to underwater communication devices, and in particular to devices which enable divers to communicate visually and over a wire by text messages with other divers, with ships, with submarines and with ocean rigs.

2. Prior Art

Divers can communicate with other divers in the same dive site in a number of ways. The simplest ways are hand signals, writing on a slate, and pointing to a particular message on a board which is pre-printed with commonly used messages.

These communication methods are limited, so a number of technologies have been developed which improve on them. U.S. Pat. No. 5,956,291 (Nehemiah et. al., 1999) describes an electronic device with a display on which text and drawings can be written. U.S. Pat. No. 4,563,758 (Patemostro, 1986) describes a device with a keyboard, a display and a voice synthesizer. Messages are entered using the keyboard. They are relayed to other divers either visually by looking at the display, or acoustically by the voice synthesizer.

The technologies described in these two patents are useful. However it would be desirable to use a simpler device to allow visual diver communication by text messages entered with a keyboard on a display. Such a device would be inexpensive, robust and reliable. This technology can handle almost any communication need among divers who are in the same dive site.

Divers also need to communicate with ships, submarines and ocean rigs. A number of technologies have been developed to accomplish this. One such technology is by text messages over a wire. The device described in the previous paragraph is used to communicate text messages visually among divers in the same location. It would be possible to modify it to include a feature to exchange text messages over a wire with an identical device located on a ship, a submarine or an ocean rig.

### SUMMARY

This invention solves the problem of communication among divers who are in the same dive site. It is a device with a keyboard and a display. A diver either chooses a message from messages that are pre-stored in memory, or enters a message through the keyboard. The message is shown on the display. The diver then shows the display to the other divers nearby and they read the message on the display. Another diver can clear the display, enter another message, and show it to the other divers who read the new message on the display.

A second embodiment of this device solves the problem of communication between divers and a ship, a submarine, an ocean rig, or between divers located at a distance. It has a serial port or a network interface or telephone modem which is used to send text messages over a wire to an identical unit on a ship, a submarine or an ocean rig. To achieve this, the unit has the ability to send messages from memory, receive messages to memory, store a number of messages in memory, and alert the user to the arrival of a message.

Both embodiments are simple, robust, reliable and inexpensive. They enhance the safety and productivity of both commercial and recreational diving. They are affordable to most divers.

### DRAWING FIGURES

FIG. 1 is the preferred embodiment of the text communication device for divers, showing the keyboard and the display.

FIG. 2 shows the deployment of the second embodiment of the text communication device for divers, showing two of these devices connected by wire through their serial ports or network interfaces or telephone modems. One unit is on a ship, and an identical unit is submerged in water, and is used by divers. The unit can also be located on a submarine or an ocean rig instead of a ship. This embodiment can also be used to communicate between two divers or two groups of divers at a distance.

FIG. 3 shows the deployment of the second embodiment of the text communication device for divers in a network. This deployment is possible if the data communication interfaces on the devices are network interfaces, for example ethernet interfaces. A typical deployment would be when a number of divers from the same ship or ocean rig work in different locations.

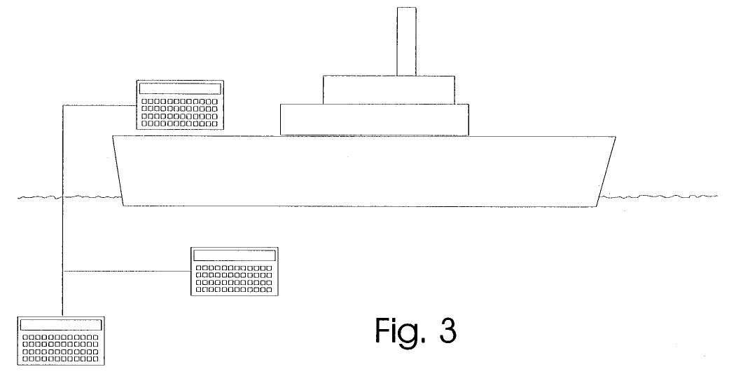

FIGS. 2 and 3 are not to scale. The text communication device is much smaller than the ship.

### DETAILED DESCRIPTION

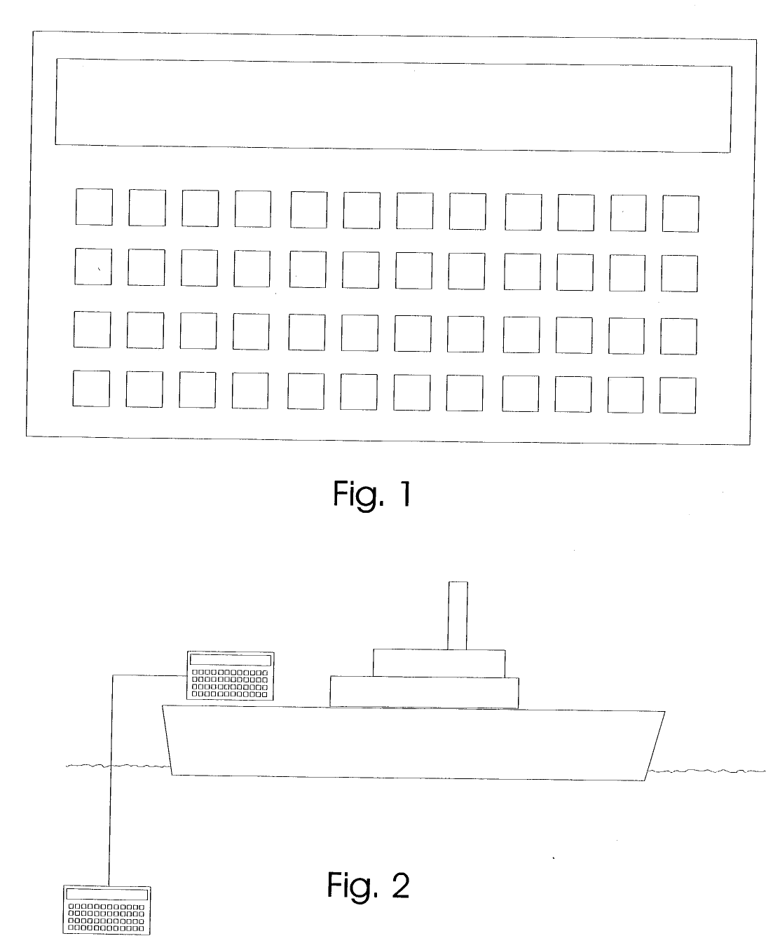

The invention is shown in FIG. 1. This is a diver communication device, which enables divers in the same location to communicate by typing messages on a keyboard. The messages are shown on a display. After typing a message, the diver shows the display to the other divers nearby, who read the message on the display. Another diver can then clear the message, type another message, and show it to the other divers. The device also has pre-stored messages, which a diver can select and display without the need to type them letter by letter. Beside pre-stored messages that are factory-set, a diver can also pre-store custom messages of his own choice that are relevant to his dives. These messages can be changed by the diver before each dive, depending on the mission of the dive.

The device comprises a housing which is waterproof and pressure resistant to diving depths, a battery, a keyboard, a display, memory and microprocessor or microcontroller. One or more ASICs (application specific integrated circuits) may replace some or all of the electronic components. The memory comprises both volatile memory and non-volatile memory.

The volatile memory, such as DRAM (dynamic random access memory), stores the messages typed on the keyboard, so that they can be shown on the display. The non-volatile memory stores messages that are preset by the factory and the diver, so that the diver can select and display a stored message, rather than having to type it letter by letter.

The non-volatile memory comprises ROM (read only memory) and flash memory. The ROM stores factory-set messages that cannot be changed or erased. These messages are standard messages used by all divers, such as the messages communicated by hand signals. Other messages can be added to this basic vocabulary and stored in ROM by the factory. Such extra messages can be found, for example, on boards with pre-printed messages that are used by divers to communicate.

The flash memory stores custom messages that are entered by the diver. The device has a mode whereby the diver types custom messages and stores them before the dive. These messages can be cleared and other custom messages stored before the next dive. The custom messages stored are relevant to the mission of each dive.

The display is either a backlit LCD (liquid crystal display) or LED display (light emitting diode). A display having a capacity between 100 and 300 characters is sufficient for most diver communication purposes. The keyboard comprises all alphanumeric keys, punctuation marks, keys to clear the display and delete a character, and function keys to select a message from the stored messages and to change the mode to a message storing mode. Other keys such as arrow keys can be included if necessary. Keys should be sufficiently spaced to allow for reduced dexterity underwater. Keys should be backlit or edge lit so that the characters on the keys are visible in the dark.

The electronic system described, comprising a keyboard, a display, memory and microprocessor or microcontroller, is known in the art. It is used in calculators, electronic organizers and handheld computers.

The device may optionally include a flashing light, so that it can be located in case it is dropped or left by the diver in a temporary storage place while the diver is working. Another optional feature is a buzzer operated by a push button, which is used by the diver to draw the attention of other divers nearby.

A second embodiment of this device enables diver communication with a ship, a submarine or an ocean rig over a wire. Refer to FIG. 2, where one device is shown underwater and is used by a diver. This unit is linked by wire to an identical device on a ship. Personnel on the ship exchange text messages with the diver through the wire. The unit can also be in a submarine or an ocean rig instead of a ship. This arrangement can also be used for communication between two divers or two groups of divers that are located at a distance.

To achieve this, the unit has the ability to send messages from memory, receive messages to memory, store a number of messages in memory, and alert the user to the arrival of a message.

This embodiment comprises a number of extra features. It has a serial port or network interface or telephone modem to send and receive data by wire. If a serial interface is used, a number of standards can be used, such as RS-232C, RS-422 or RS-485. If a network interface is used, the most commonly used network standard is ethernet. A standard telephone modem such as a V.90 or a V.92 modem can also be used as a data communication interface. A suitable wire medium connects the units, depending on the communication standard used.

Another feature that this embodiment includes is a means to call the attention of the user to the arrival of a message. This can be a buzzer or light or both. A further feature is memory to store previous messages and a means to display them and to page through them. This is necessary because, when a message is sent, it is not always known whether the user at the receiving end is next to the unit and is ready to read the message. It is not always known whether the other user has already read the previous message. Therefore, it is unsatisfactory to have the unit display just the last message, and have the last message erase the message before it. Ideally, the unit should also store the last few messages that were sent, beside the last few messages received. This enables the user to page through the complete message dialogue.

If the data communication interface used in the text communication device is a network interface, for example an ethernet interface, it is possible to connect multiple units to the wire, forming a network. Refer to FIG. 3. This deployment is useful when a number of divers from the same ship or ocean rig work in different locations. A user can select whether to send a message to all the other users or only to some of them.

The technology described is known in the art. It is data communication using terminals, either serial terminals or network terminals or modem terminals.

The foregoing description of the preferred embodiment of the invention and some possible variations has been presented for the purposes of illustration and description. It is not intended to be exhaustive or to limit the invention to the precise form disclosed. Many modifications and variations are possible. It is intended that the scope of the invention be limited not by this detailed description, but rather by the claims appended hereto.

I claim:

1. Text communication device for divers comprising a keyboard, a display, and housing that is water proof and pressure proof to diving depths, whereby a diver enters a text message using said keyboard, the message is shown on the display, and other divers nearby read the message on the display.

2. The text communication device for divers in claim 1, wherein said device further comprising read only memory, said read only memory storing factory preset messages, whereby a diver, using said keyboard, can select any one of said factory preset messages for showing on said display.

3. The text communication device for divers in claim 1, wherein said device further comprising flash memory, whereby a diver can store custom messages prior to a dive, and later, during a dive, a diver, using said keyboard, can select any one of said custom messages for showing on said display.

4. The text communication device for divers in claim 1, wherein said display is backlit LCD (liquid crystal display).

5. The text communication device for divers in claim 1, wherein said display is LED (light emitting diode) display.

6. The text communication device for divers in claim 1, wherein said keyboard is backlit.

7. The text communication device for divers in claim 1, wherein said keyboard is edge lit.

8. The text communication device for divers in claim 1, wherein said device further comprising a buzzer that is operated by a push button, whereby a diver can draw the attention of other divers.

9. The text communication device for divers in claim 1, wherein said text communication device further comprising an interface driving data communication over a wire means, other end of said wire means is connected to an identical text communication device located elsewhere, whereby a diver can exchange text messages with a user of said identical device via data communication over said wire means.

10. The text communication device for divers in claim 9, wherein said device further comprising a means to draw the attention of a user to the arrival of a message, such as a buzzer or light or both.

11. The text communication device for divers in claim 9, wherein said text communication device retains text messages sent and received, whereby a user can page through the messages.

12. The text communication device for divers in claim 9, wherein said interface uses a telephone modem for data communication.

13. The text communication device for divers in claim 9, wherein said interface uses a serial data communication standard.

14. The text communication device for divers in claim 13, wherein said interface uses the RS-232C serial data communication standard.

15. The text communication device for divers in claim 13, wherein said interface uses the RS-422 serial data communication standard.

16. The text communication device for divers in claim 13, wherein said interface uses the RS-485 serial data communication standard.

17. The text communication device for divers in claim 9, wherein said interface is a network interface.

18. The text communication device for divers in claim 17, wherein said interface uses the ethernet network standard.

19. The text communication device for divers in claim 17, wherein a plurality of said text communication devices for divers are connected to said wire means, forming a network.

20. The text communication device for divers in claim 19, wherein said text communication device for divers enables a user to select which other said devices on said network receive a message.
